(19) United States
(12) Patent Application Publication
(10) Pub. No.: US 2014/0123764 A1
(43) Pub. Date: May 8, 2014

(54) Fiber Bragg Grating Pressure Sensor with Adjustable Sensitivity

(71) Applicants: Mohammad Abtahi, Montreal (CA); Pin Long, Montreal (CA); Nikolay Naydenov, Montreal (CA)

(72) Inventors: Mohammad Abtahi, Montreal (CA); Pin Long, Montreal (CA); Nikolay Naydenov, Montreal (CA)

(21) Appl. No.: 13/668,378

(22) Filed: Nov. 5, 2012

(51) Int. Cl. G01L 11/02

(52) U.S. Cl. CPC G01L 11/025
USPC 73/705

(57) ABSTRACT

A new type of optical pressure sensor with adjustable sensitivity is proposed based on the fiber Bragg grating (FBG). In this technique, the pressure changes the length of a metal bellows which is placed behind a spring. The fiber grating is fixed over the bellows between a fixed position and the connection point of bellows and spring. The wavelength change of FBG is caused by the change in the bellows length; however, the spring controls the total length expansion of the bellows. It will bring two benefits: first it is easy to change the pressure sensing range by changing the spring rate; and secondly the spring improves the linearity of the wavelength sift due to the pressure. The FBG is installed outside of the bellows and is not in contact with the material in which the pressure should be measured (gas or liquid) in contrast with other pressure sensors where the FBG is inside the bellows. This is an important issue because some materials could damage or change the characteristics of the fiber over the time.

The pressure range and the sensitivity of the proposed pressure sensor can be adjusted over a wide range simply and only by tuning two calibration screws, while all components of sensor remain the same.

### BACKGROUND OF INVENTION

The pressure sensors are used in various pressure ranges and sensitivities in different applications including medical, military and civil applications as well as in the oil and gas industries. The three major technologies for pressure measurement with optical fiber sensors (OFS) are intensity-based, Fabry-Pérot and fiber Bragg gratings (FBG). Each of them has some advantages and drawbacks which make them the best choice for some applications.

In the first technique, the coupled light intensity into an optical fiber is changed when the pressure moves a membrane. The membrane movement, however, in the Fabry-Pérot sensors changes the cavity length. The interference pattern created by the cavity could be used to measure the diaphragm deflection and thus the pressure change.

Since FBG intrinsic pressure sensitivity is not very high, the FBG-based OFS are normally designed to measure the pressure indirectly by measuring the strain instead which increases the sensor sensitivity due to the good silica behavior under strain.

In the various proposed approaches a FBG is fixed or attached to an elastic structure (e.g. diaphragm, bellows, etc.) which acts as a sensing element [1, 2, 3]. The sensing element compresses or strains the FBG depending on the structure. The resulting shift in the center wavelength of the FBG could be used for the pressure monitoring.

For instance, in the proposed structure in U.S. Pat. No. 6,820,489 by Mark R. Fernald et al. [1], a bellows is used as the sensing element, where the FBG is fixed inside. Another structure using bellows is proposed by N. Coleman in U.S. Pat. No. 6,604,427 [3].

There are some problems with fiber pressure sensors based on the bellows: first the regular small-sized bellows has low spring rate and cannot be used to measure high pressures; second the fiber pressure sensor made from bellows does not present a linear relationship between pressure and wavelength shift.

The sensitivity is a major parameter of all pressure sensors; however, it depends on the pressure range. The high sensitive sensors are preferred when the pressure range is small. On the other hand, for the wide pressure range a less sensitive sensor is preferred. In many proposed structures, the sensitivity cannot be adjusted easily and for each case a new design should be provided. Here in this invention, we proposed a simple technique to adjust the sensitivity of the FBG pressure sensor in a wide range using the calibration mechanism while all other components in the structure remain the same. Using a spring behind a bellows, we control the displacement of the sensor element due to the pressure and as a result the total sensor sensitivity. This is particularly important from the manufacturing point of view as a single design can be used for various applications with different requirements of sensitivity and pressure range.

### OBJECTS OF THE INVENTION

An object of the present invention is to provide a novel technique for the pressure sensor based on fiber grating.

Another object of the present invention is to adjust the sensitivity of the proposed pressure sensor over a wide range.

Another object of the present invention is to adjust the sensitivity of the proposed pressure sensor using a calibration screw.

Still another object of the present invention is using the same pressure sensor for various pressure ranges.

Still another object of the present invention is to adjust the pressure range of the sensor by a calibration screw.

Still another object of the present invention is avoiding the direct contact between the FBG and the material (gas or liquid) in which the pressure is measured.

### SUMMARY OF THE INVENTION

According to the present invention, a fiber grating is stretched by a metal bellows depending on the applied pressure to the bellows. The changes in the central wavelength of the grating can be monitored by an interrogation system for pressure monitoring.

The present invention represents a technique in which the sensitivity and the pressure range of the sensor can be adjusted by some calibration screws. It is important from the manufacturing point of view as the same sensor can be used for various applications where different sensitivity is required. Normally, when the pressure range is wide a lower sensitivity is required and on the other hand, high sensitive sensors are used for measuring the pressure over the small ranges. The same pressure sensor as proposed in this invention can be used in all those cases.

Furthermore, the FBG in the proposed structure is not in contact with the material in which the pressure should be measured (gas or liquid). Note that some materials could damage or change the characteristics of the fiber over the time.

### BRIEF DESCRIPTION OF THE DRAWINGS

For a better understanding of the present invention, reference is made to the following detailed description and the attached figures, where:

FIG. 1 is a schematic diagram of the pressure sensor using a metal bellows and a spring, in accordance with the present innovation.

FIG. 2 shows the displacement of bellows and spring due to the calibration screws (part a) and the applied pressure (part b), in accordance with the present innovation.

FIG. 3 is a general nonlinear spring profile and its modeling by a multi-segment profile, in accordance with the present innovation.

FIG. 4 shows a structure to initially compress the spring by certain length, in accordance with the present innovation

FIG. 5 shows the combine schematic diagram of the sensor including the structure for the spring initial compression, in accordance with the present innovation.

FIG. 6 shows the wavelength shift versus pressure for various sensitivities, in accordance with the present innovation.

### DETAILED DESCRIPTION OF THE PREFERRED EMBODIMENTS

With reference to the annexed drawings the preferred embodiment of the present invention will be herein described for indicative purpose and by no means as of limitation.

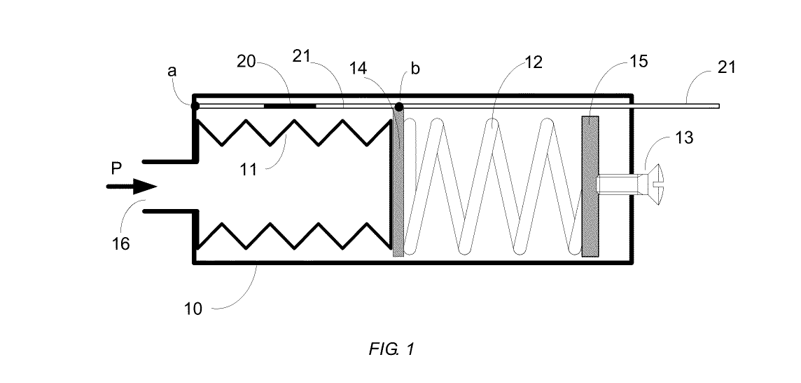

Referring to FIG. 1, there is shown the principles of the present invention in a schematic diagram where a metal bellows 11, a spring 12 and a screw 13 are connected and fixed to each other using the connectors 14 and 15. All components are tightly placed in a cylindrical metal tube 10. The tube 10 is completely sealed except for a hole 16 to let the gas (or liquid) with a pressure of P enter the bellows.

A fiber Bragg grating 20 written in a piece of optical fiber 21 is fixed to the tube at one end in point “a” and to the connector 14 in point “b”. The fiber 21 goes then out of tube 10 and will be connected to the sensor interrogation system for pressure monitoring. When the pressure inside the below is higher than the air pressure, the bellow expands and as a result the FBG will be stretched and a wavelength shift can be observed by the sensor interrogation system.

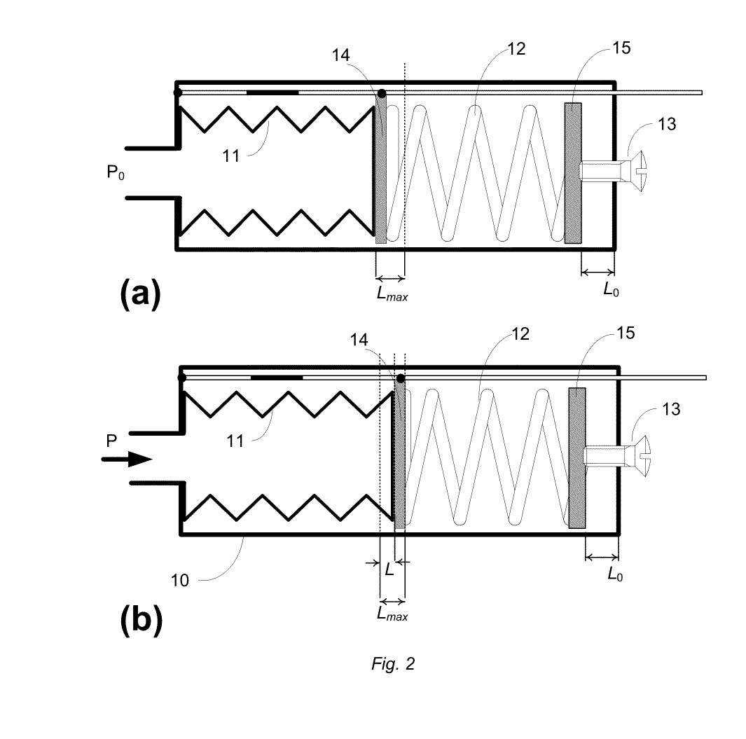

Referring now to FIG. 2 where the displacements in bellows are compared without and with pressure in part (a) and (b), respectively. Without an external pressure (actually air pressure, P₀), the screw 13 is fixed with an initial displacement of L₀ in connector 15. This displacement moves the connector 14 by a displacement of Lₘₐₓ, which is related to the initial displacement of L₀ by: Lₘₐₓ.=kₛ L₀/(k_{b}+kₛ), where k_{b} and kₛ are the spring constants of the bellows 11 and spring 12, respectively. When the pressure P is applied to the bellows (FIG. 2b), the end side of the bellows, i.e. the connector 14 is moved by displacement L, which is proportional to the applied pressure by: P,A=−(k_{b}+kₛ)L, where A is the bellows effective area. The maximum theoretical pressure that can be measured is determined by the maximum displacement Lₘₐₓ through Pₘₐₓ=−kₛ L₀ /A. Therefore, the screw 13 could be used to adjust the pressure range of the sensor.

The relative shift of the Bragg wavelength Δλ_{B} due to the displacement L can be obtained from the well-known relation Δλ_{B}/λ_{B}=αL/D, where λ_{B} is the FBG center wavelength and D is the fiber length before strain. a is a parameter related to photoelastic coefficient of the fiber and is about 0.79 [4]. By combining the above equations, the direct relation between pressure and shift of the Bragg wavelength can be found as: Δλ_{B}=−(αλ_{B}/D) (A/(k_{b}+kₛ)) P.

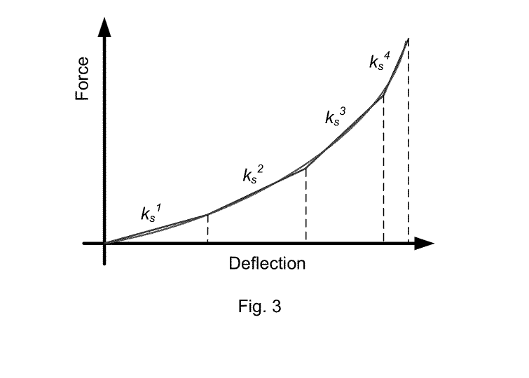

In this invention we present a technique to change the sensitivity of the sensor by changing the spring constant kₛ. We now refer to FIG. 3 in which a general nonlinear spring profile is shown. The force versus deflection function of the spring could be modeled by a multi-segment profile. In each region the spring constant is different.

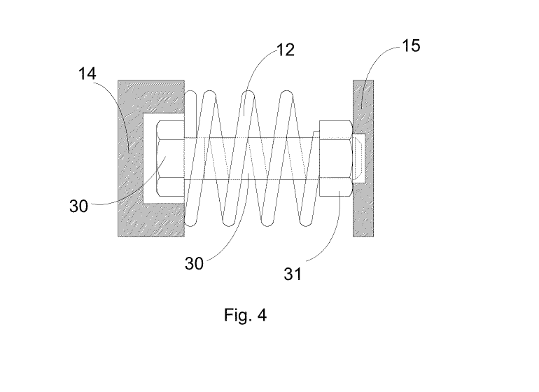

By compressing the spring, the spring constant can change from kₛ¹ to kₛ² and so on, which lets us to adjust the sensor sensitivity. Note that the spring constant increases with the deflection (i.e. kₛ¹<kₛ²<kₛ³ . . . ). To profit this feature, we use and structure as shown in FIG. 4 to compress the spring by certain length before posing it behind the bellows. A screw 30 and a nut 31 are used to first compress the spring to a desired level and adjust the spring constant. Then connector 14 is modified as shown in FIG. 4 to touch the spring when the pressure applies.

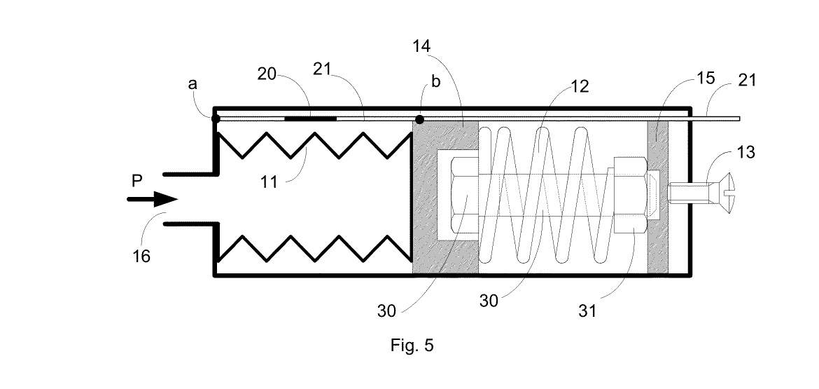

The whole new structure is shown in FIG. 5. This structure is able to provide a wide sensitivity range as well as the measuring pressure range only by adjusting the two calibration screws 13 and 31 when all the components in the system are the same.

In the applications where the temperature is not constant, the 2^{nd} Bragg grating can be written on the same fiber 21 along the first FBG 20 to measure the temperature change and compensate the resulting wavelength shift.

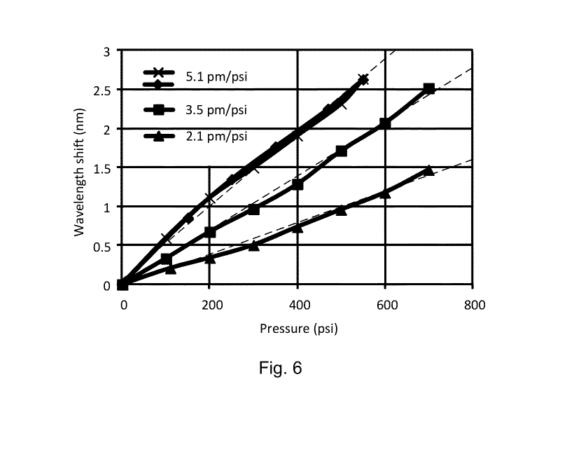

To demonstrate the capability of the proposed technique in this invention, the wavelength shift is measured over a pressure span of more than 700 psi. By adjusting the two calibration screws 13 and 31, various sensitivities from 2 to 5 pm/psi are achieved. The wavelength shift versus pressure is shown in FIG. 6, in which lines are also plotted for the comparison. The measured results follow well the lines. The small deviation from the linear curves could be due to the resolution of the pressure measuring device. Furthermore, two curves with the sensitivity of 5.1 pm/psi are measured when the pressure is increased and decreased, respectively. They are in good match indicating that there is no hysteresis with the pressure sensor.

### REFERENCE

U.S. Pat. No. 6,820,489.
U.S. Pat. No. 6,668,656.
U.S. Pat. No. 6,604,427.
A. locco, et al., “Bragg Grating Fast Tunable Filter for Wavelength Division Multiplexing,” J. Lightwave Technol., vol. 17, no. 7, pp. 1217-1221, July 1999.

We claim:

1. A fiber Bragg grating pressure sensor, comprising a fiber Bragg grating connected to a metal bellows and a spring in which its spring constant can be adjusted by the screws in order to provide adjustable not only the pressure sensitivity but also the measuring pressure range.

2. A device as defined in claim 1, where said fiber grating is installed outside and connected to a metal bellow.

3. A device as defined in claim 1, where a spring is used behind the metal bellows to control and adjust the bellows displacement due to pressure.

4. A device as defined in claim 1, where the pressure sensor sensitivity can be adjusted.

5. A device as defined in claim 1, where the measuring pressure range can be adjusted.

6. A device as defined in claim 1, where the 2^{nd} fiber grating is used to measure the temperature variations.

7. A device as defined in claim 1, where both fiber gratings are written in the same fiber.

8. A device as defined in claim 1, where the fiber gratings are written in different fibers.

9. A device as defined in claim 1, where both or any of fiber gratings are used in transmission.

10. A device as defined in claim 1, where both or any of fiber gratings are used in reflection.
